(19) United States
(12) Patent Application Publication
(10) Pub. No.: US 2009/0241529 A1
(43) Pub. Date: Oct. 1, 2009

(54) Hydraulic machine consisting of two identical rotors

(76) Inventor: Gino Franch, Bolzano (IT)

Correspondence Address: JACOBSON HOLMAN PLLC, 400 SEVENTH STREET N.W., SUITE 600, WASHINGTON, DC, 20004, US

(21) Appl. No.: 12/382,731

(22) Filed: Mar. 23, 2009

(30) Foreign Application Priority Data
Mar. 31, 2008 (IT) BZ 2008 A 000 031

(51) Int. Cl. F15B 13/06

(52) U.S. Cl. 60/325

(57) ABSTRACT

Hydraulic machine consisting of two identical rotors comprises two identical rotors R₁ ed R₂, to which the identical tubular circuits (C₁, C₂) and (C₃, C₄) are respectively attached, which with appropriate connections form two series S_{c1}=(C₁, C₃) and S_{c2}=(C₂, C₄), the equal and opposite oscillating movement generating alternatively in the liquid of each series an identical pulse of forces adapted to the operation of a pump or a turbine; an aₘₐ crankshaft imposing on R₁ ed R₂ an equal and opposite oscillating movement by means of the rod pistons b_{1.2} and the cranks ma_{1,2}; in R₁ in θ (0°, 90°) of aₘₐ it is developed the right-handed force of C₁ and in θ (180°, 270°) the left-handed force of C₂; while in R₂ it is developed the force of C₃ e C₄ respectively in θ (180°,270°) and in θ (0°, 90°).

The present invention refers to a hydraulic machine according to the identifying section of claim 1. Machines of this known type are relatively complicated, having an efficiency that can still be increased and can operate only as a pump or a turbine.

The object of the present invention is that of perfecting a hydraulic machine of the known type.

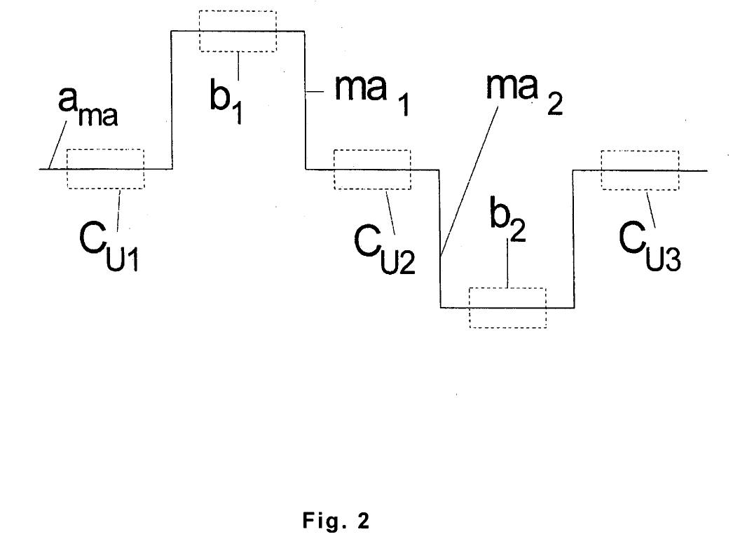

This object is achieved by a hydraulic machine with the characteristics of the identifying section of claim 1. The machine consists of the following components:
a) the two identical rotors R₁ and R₂, to which the identical tubular circuits (C₁, C₂) and (C₃, C₄ are attached respectively;
b) an aₘₐ crankshaft imposing on R₁ and R₂ an equal and opposite oscillating movement by means of the piston rods b_{1.2} and the cranks ma_{1,2}; the ensemble is pre-arranged in such a way that in R₁ in the interval θ (0°, 90°) of aₘₐ, the right-handed force of circuit C₁ is generated and in the interval θ (180°, 270°) the left-handed force applied to C₂; while in R₂ the force of circuits C₃ and C₄ is generated respectively in θ (180°,270°) and in θ (0°, 90°). The value of the force generated by the machine is proportional to the mass m_{c} contained in each circuit R_{1,2}; the mass can be increased by adding to each circuit C_{i,j}, an integer number Nₒ of turns with barycentric radius r_{B} and with a section S_{c} equal to that of C_{i,j}-. In this way, the mass of each circuit C_{i,j} is equal to a m_{c}(1+4N₀). The power generated by the machine is also proportional to \dot{θ}³ that is to the cube of the angular speed of aₘₐ. In this way, the value of the machine power can vary from a minimum value to a very high value;
c) for operation as a pump PO, E_{PO} is opened and E_{TU} is closed; for operation as a turbine, E_{TU} is opened and E_{PO} is closed;
d) the power generated by the two rotors is transferred to the crankshaft aₘₐ by means of the piston rods b₁ e b₂
e) the crankshaft aₘₐ (FIG. 2) as pump operating machine is connected with a motor that furnish the absorbed energy; the crankshaft aₘₐ is connected with the user of the generated energy as turbine operating machine.

### Advantages of the Machine

1) Simple to build.
2) High efficiency due to the relatively low losses of its circuits.
3) Operation as a Pump or Turbine obtained by varying the direction of speed of the liquid.
4) Possible operation also with thick liquids, granulated solids and with a mixture of small size solids.
5) Relatively low building costs.
6) Possible operation also with significant power variations according to the variation of the angular rotation speed of aₘₐ without noticeable changes in efficiency.
7) Perfect balancing of the two rotors R_{1,2} and the crankshaft aₘₐ due to the machine operation, envisaging the advantage of a support frame TS put under strain only by the weight of the two rotors and of the crankshaft, as the TS is not affected by the functional strains of the machine.

Further features are shown in the claims and the following description of a preferred embodiment, depicted in the attached drawing, wherein

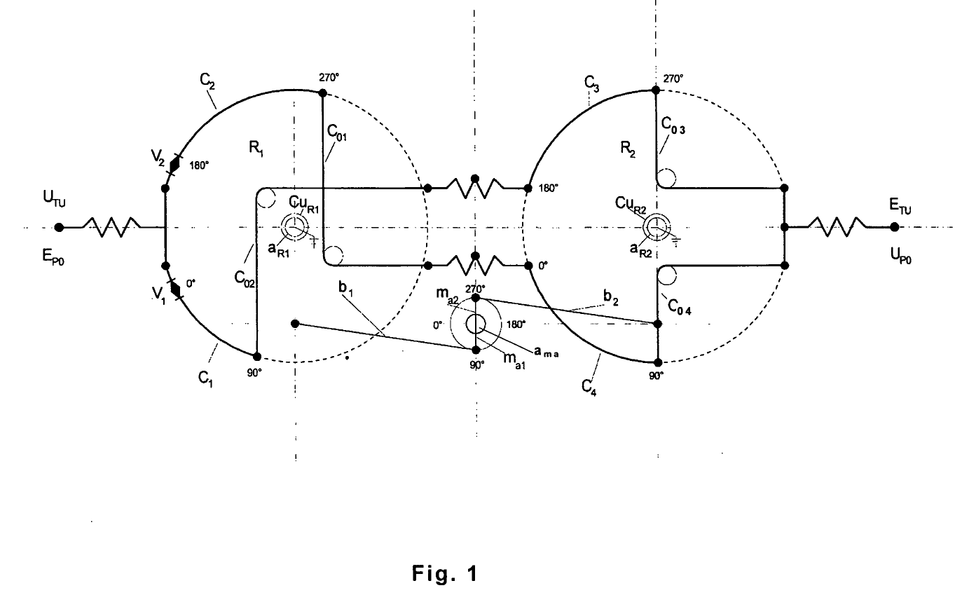

FIG. 1 represents schematically the circuits of a hydraulic machine according to the invention, and

FIG. 2 shows schematically the piston rods and the cranks connected to the circuits.

### DESCRIPTION AND OPERATION OF THE MACHINE

The machine consists of the following components:
1) two identical rotors R₁ and R₂ (FIG. 2/3) arranged on a support frame TS; the circuits C₁ and C₂ are attached to R₁ and the circuits C₃ and C₄ are attached to R₂;
2) the valve V₁ opened only in θ (0°, 90°), developing the series of circuits (C₁+C₃) and the valve V₂, opened only in θ (180°, 270°), developing the series of circuits, (C₂+C₄)
3) a crankshaft aₘₐ represented in FIG. 1 with its axis parallel to that of R_{1,2}; to which the two cranks mₐ₁ and ma₂ are attached with the details shown in FIG. 1; the cranks mₐ₁ and mₐ₂ fixed to the crankshaft aₘₐ are connected respectively to the head of the piston rod b₁ and b₂, whose foot is connected respectively to rotors R₁ and R₂ at a far point r₀ of the rotary axis.

The crankshaft aₘₐ causes the oscillating movement of the two rotors, whose angle of rotation φ satisfies the following equation:

φ=φₒ sin θ, (1)

where φ is the angle of rotation of the rotor

### R_{1,2}

By deriving (1) the angular speed of the rotor R_{1,2} is obtained:

\dot{φ}=φ₀\dot{θ} cos θ (2)

from which the rotation speed of the active circuits Cᵢ is obtained

V_{Ci}=φ₀r_{B}\dot{θ} cos θ (2)

where r_{B} is the barycentric radius of the tubular circuit; \dot{θ}=2πnₒ is the angular speed of the crankshaft aₘₐ; and nₒ is the number of revolution/s of the latter. Deriving (3) with respect to the time and multiplying it by the mass m_{c} contained in the circuit C_{i,j} the equation of the force applied to m_{cj} can be obtained,

f_{c}=−m_{c}φ₀r_{B}\dot{θ}² sin θ (4)

Based on the above, the value of the power absorbed by the machine operating as a pump is proportional to the relation

−m_{c}φ₀²r_{B}²\dot{θ}³

The power of the machine increases with the cube of the rotation speed of the crankshaft aₘₐ and the increase in mass of Cᵢ; by adding to each active circuit an integer number N₀ of turns of radius r_{B} and section S_{c} the total mass of C_{i,j} is:

m_{0c}=m_{c}(1+4No); (5)

therefore the power absorbed by the machine operating as a pump increases with the 3 An equal but opposite value applies for operation as a turbine.

From the analysis of FIG. 1 the following important relation is derived:

(6) The crank ma_{1,2} of crankshaft am produces the oscillating movement of rotors R_{1,2}, with which it is connected through crankshaft b_{1,2}.

1. Hydraulic machine consisting of two identical rotors characterised in that it comprises
a) two identical rotors R₁ ed R₂, to which the identical tubular circuits (C₁, C₂) and (C₃, C₄) are respectively attached, which with appropriate connections form two series S_{c1}=(C₁, C₃) and S_{c2}=(C₂, C₄), the equal and opposite oscillating movement generating alternatively in the liquid of each series an identical pulse of forces adapted to the operation of a pump or a turbine;
b) an aₘₐ crankshaft imposing on R₁ ed R₂ an equal and opposite oscillating movement by means of the rod pistons b_{1.2} and the cranks ma_{1,2}; the ensemble is designed in such a way that in R₁ in the interval θ (0°, 90°) of aₘₐ it is developed the right-handed force of circuit C₁ and in the interval θ (180°, 270°) the left-handed force applied to C₂; while in R₂ it is developed the force of circuits C₃ e C₄ respectively in θ (180°,270°) and in θ (0°, 90°). The value of the force generated by the machine is proportional to the mass m_{c} contained in each circuit R_{1,2}; the mass can be increased by adding to each circuit C_{i,j}, an integer number Nₒ of turns with barycentric radius r_{B} and with a section S_{c} equal to that of C_{i,j}-. In this way, the mass of each circuit C_{i,j} is equal to a m_{c}(1+4N₀). The power generated by the machine is further proportional to θ³, that is to the cube of the angular speed of aₘₐ. In this way, the value of the machine power can vary from a minimum value to a very high value;
c) for operation as a PO pump, E_{PO} is opened and E_{TU} is closed; for operation as a turbine E_{TU} is opened and E_{PO} is closed (see FIG. 2/3);
d) the power generated by the two rotors is transferred to the crankshaft aₘₐ by means of the piston rods b₁ and b₂.

2. The use of a machine according to claim 1, characterised by each series of circuits S_{c1}=(C₂+C₃) and S_{c2}=(C₂+C₄) with opening and closing respectively for θ (0°,90°) and for θ (180, 270°), the use of each series having the great advantage of simplifying the operation and increasing the efficiency.

3. Machine according to claim 1, characterized in that the connection system C_{Di} consisting of a tube whose length is 2_{rB} and internal diameter is d_{C} and curved half way along at an angle of 90° and with the apex arranged on the same rotation axis of the rotor; by eliminating the coupling with rotation forces, it connects the circuits of each pair (C₁, C₃) and (C₂, C₄) and by eliminating the pair of centrifugal forces of each connection; there are 4 connection tubes, 2 of which are attached to R₁ and 2 are attached to R₂.

4. The use of the machine as a pump or a turbine according to claim 1, by varying the direction of speed of the liquid of the active circuits.

5. Use of the machine according to claim 1, characterized in that the increase in power generated in each circuit by means of a series of turns, whose mass is m_{c}(1+4N₀), where 4N₀ is the integer number of the series of turns added.

6. Machine according to claim 1, characterized by the following characteristics:
a) high efficiency since the liquid flows into a circuit with constant section and completely free of pistons and hydraulic impellers;
b) possibility to vary the speed of the crankshaft, the machine power varying according to the crankshaft speed cube power; this increases the number of applications.

7. Use of the machine according to claim 1, characterized in that it is also used for pumping and transporting thick liquids, granulated solids or small size solids.

8. Machine according to claim 1, characterized by the arrangement of the two rotors on a single rotation axis, respect to which the crankshaft is parallel; in this way, the maximum dimensions of the machine can be reduced;

9. Machine according to claim 1, characterized by the balancing of each component of the machine implemented so as to prevent the transmission to the support frame of each detail of its operation.
